(19) United States
(12) Patent Application Publication
(10) Pub. No.: US 2021/0097509 A1
(43) Pub. Date: Apr. 1, 2021

(54) Process and system for keeping track of loose change

(71) Applicant: Gary Omotoy, III, Ontario, CA (US)

(72) Inventor: Gary Omotoy, III, Ontario, CA (US)

(21) Appl. No.: 16/585,535

(22) Filed: Sep. 27, 2019

(51) Int. Cl. G06Q 20/06; G06Q 20/38; G06Q 20/32

(52) U.S. Cl. CPC G06Q 20/065; G06Q 20/3274; G06Q 20/389

(57) ABSTRACT

The current invention is a mobile smartphone application is to make carrying cents and storing cents more convenient for people by taking physical cents and turning it into cryptocents. The cryptocents is then stored in on mobile devices making carrying cents hassle free. Instead of physical cents you are receiving digital cents with the same spending power. Cents will always be saved in one place.

### CROSS-REFERENCES TO RELATED APPLICATIONS (IF ANY)

None

### BACKGROUND

### 1. Field of the Invention

The present invention relates to a process and a money-saving app for a smartphone that keeps track of loose change.

### 2. Description of Prior Art

People just hate walking around with their pockets jangling with loose change. Ther purses and pockets weighing a ton from all the coins their carrying. Not only is it heavy and inconvenient, but they usually end up losing their coins or giving them away.

There is still room for improvement in the art.

### SUMMARY OF THE INVENTION

The current invention is a system and application that makes carrying cents and storing cents more convenient for people by taking physical cents and turning it into cryptocents. The cryptocents is then stored electronically in a device such as a smartphone, iPhone or other mobile device. This makes carrying cents hassle free. This app gives people the option to carry cents in a new way. Whether its physical quarters, dimes, nickels, pennies or digital cryptocents, the user chooses how they want to carry their cents. What makes this app different is that it is simple to use and is the first app developed in the sense that a person is storing and saving physical cents they might get back after any purchase. Instead of physical cents they are receiving digital cents with the same spending power. Cents will always be saved in one place. This makes carrying cents smarter and much easier.

The system, in the preferred embodiment, would work like a smartphone application, this product would be available through the respective marketplace for smartphones.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system; and

FIGS. 2 and 3 shows a samples of a transfer screens.

### DESCRIPTION OF THE PREFERRED EMBODIMENT

There are a number of significant design features and improvements incorporated within the invention.

The current invention is a system and application (app) 1 for taking physical cents and turning it into cryptocents. The cryptocents is then stored in computing devices 20 such as smartphones, iPhones and other mobile devices. What makes this app 1 different is that it is simple to use and is the first app developed in the sense that a user is storing and saving physical cents they might get back after any purchase. Instead of physical cents the user is receiving digital cents with the same spending power. Cents will always be saved in one place. This makes carrying cents smarter and much easier.

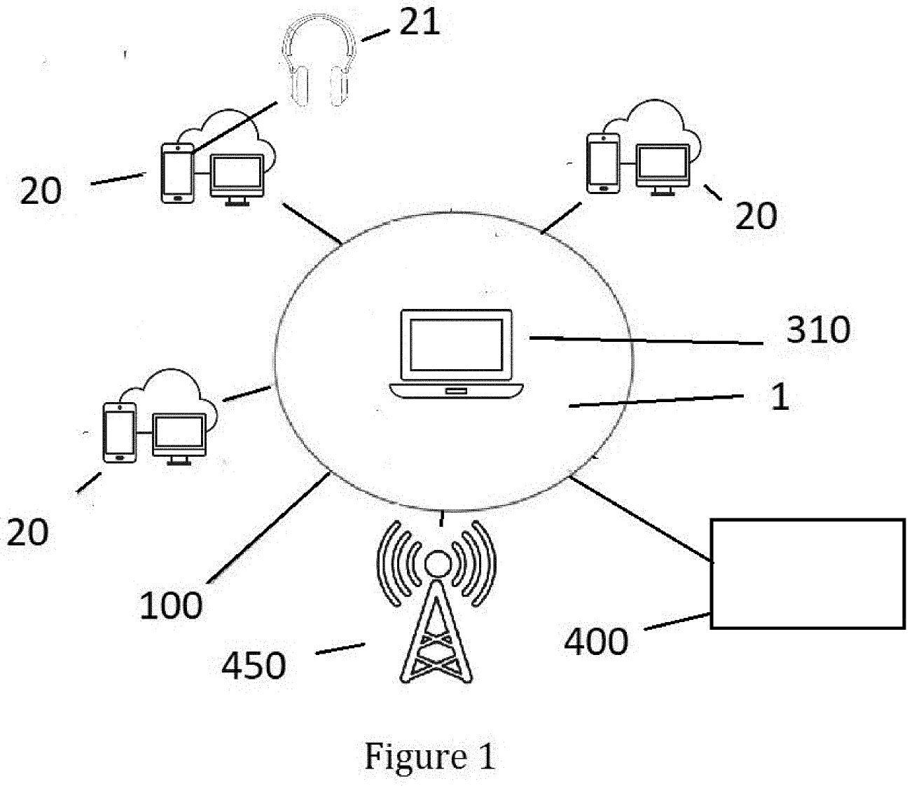

FIG. 1 displays the preferred embodiment of the system architecture 1 which can be accessed through an Internet, Intranet and/or Wireless network 500. However, the system could be implemented on a single device, device-to-device, wirelessly or client/server architecture as well.

In FIG. 1, the system 1 is accessed from a user's smart phone 20 through a web browser over HTTP and/or HTTPS protocols 500 or wireless network or cell phone to cell phone connection. A smart phone 20 that can access the system 1 must have some version of a CPU, CPU memory, local hard disk, keyboard/keypad/input and display unit. The smart phone 20 can also be replaced by another computing device such as a desktop, laptop, tablet or general purpose computing device with an appropriate amount of memory suitable for this purpose and may or may not have an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each smart phone 20 communicating with others within the system 1 or the system 1 could be on a standalone device 20.

The system 1, data and processing code can reside in the non-transitory memory 310 of the one or more computing devices. The system 1 in the preferred embodiment would be written to act like a smart phone application (app).

The type of coding languages that best suits this app platform for Android platform and iPhone platform are HTML5, css, JavaScript, C++, intel XDK, Linux, mac os, windows, android SDK, eclipse IDE, intellij IDEA, reddit, JDK, Net Beans IDE, objective c. swift, swift 2, cocoa, cocoa touch, r, python, typescript, jquery, dart, groovy, ruby, Smalltalk, xss, visual basic.net, java, react, react native, c#, c go, rust, php, peri, apache 2.0, mantis, XCode, Xamarin, phonegap, appcelerator, rhomoblie, unity, Sencha, cocos2d. This app will be for Android platform on the google app store as well as iPhone platform on the Apple iOS App store. Should be able to orchestrate this app using a platform that will create and run this app across all commercially dominant operating systems such as windows, Linux, osx, iOS, android etc.

The first thing a user must do before they are able to use the app 1 is to create their sign-up user information which is required before the app 1 can be used. The required fields are first and last name, home address, current email address, driver's license number and current phone number. Once completed they may begin using the app 1.

There will be a unique identification code such as a barcode located directly on the screen of the computing device 20 or a wireless communication means. This is where cashiers will scan the ID or computing device 20 to add cents to a user's account. Once a cashier scans the barcode the word “Accepted” will pop up above the ID to notify the user that the transaction was successful. A Bluetooth connection may also be used.

The system 1 will have a menu bar.

The first tab on a menu bar will read “Account Activity” click on it and it will open up to a screen with two tabs located at the top of the page reading “Recent and Previous.” This is where a user will click if they want to go to review any recent or previous transactions.

It will show all the places a user can add or deduct cents from, along with the name of the business. The amount added or deducted will be highlighted, added in green and deducted in red. It will also show the amount added or deducted as well. This page will be set up in a column format. It will start with the date, followed by the amount and then followed by the business name and last the transaction. At the top of the right hand corner, it will show the total available cents in an account which will be displayed under the words “Cents Available.”

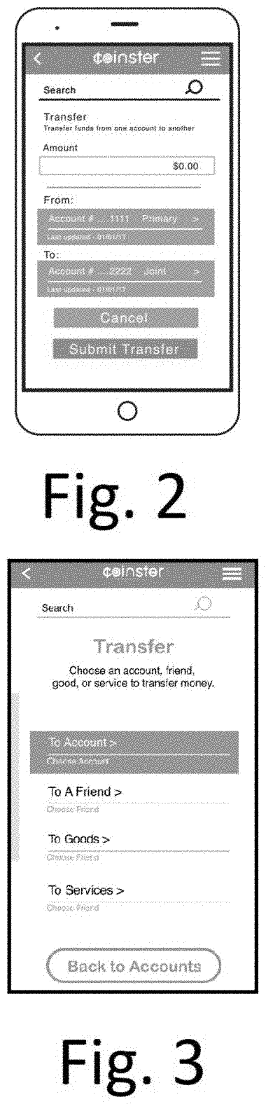

The next tab located under the account activity tab will read “Transfer To.” The function and purpose of this tab is to transfer cents to from a bank account or another User of this app such as friends, family etc. as shown in FIGS. 2 and 3. When using the “Transfer To” tab, there will be three separate circle choices to choose from. The first circle clicked to enable this function will read “Goods and Businesses.” This is for fast food, retail businesses, gas stations, liquor store, toll roads, grocery stores, coin stars, restaurants, tips, internet, and any businesses that deal with cents on a daily basis. The application 1 has a function “Other Users.” This function sends cents to other users of this app if they need change. When highlighted, a page will appear where a user can type in the person's phone number they want to send cents to. Underneath is a spot to type in a phone number so the user knows who is sending cents to them. Under that is where a user will put the amount of cents they want transferred to the other user. When they are finish adding the amount they want to transfer, hit the send button located at the bottom of the page to complete the transaction. The third and last circle will read “Bank Account.” This is where a user will click when they are going to transfer funds into their personal bank account. When transferring funds to their personal bank account type in their bank account wiring number along with the rest of your bank account information. There will be a box to type in for each one of these required fields, account number, name of bank, send to primary account, authorization number, transaction number, transfer amount and finally the pin number. Once a user has completed filing in all their personal information required to transfer funds to your personal bank account, they will then double check to make sure everything is correct. When finished they then click the “send button” located at the bottom of the page. The funds will be transferred directly to their personal bank account.

The next tab that appears under the transfer to tab will read “Deduct.” This is where a user will need to go to deduct cents for tax from their account when purchasing anything. There is a box where they enter the amount needed to be deducted. Underneath the box are numbers and at the very bottom is a barcode. When cents is needed for tax, click the “Deduct Tab,” then simply type in the amount that needs to be deducted and have the cashier scan the barcode at the bottom of the page. The amount should disappear from the box and that will let you know it was successful in deducting cents from their app account.

The second to the last tab directly underneath the deduct tab on the menu bar will read “Individual Cents.” The purpose of this page is to show how much each individual cents a user have accumulated and saved on their app account. It will show how many total quarter a user have in their account, how many total dimes they have, the total amount of nickels they have and finally how many pennies they have in total. Each individual cent will have a number located under it. This will give the total amount of each individual cents currently in your app account.

The system 1 has “How To” function. This is where all instructions and functions on how to use this app 1 can be found. This will also be where a user's account sign up information is located in case any changes need to be made in the future. It also has private policy, terms of service, about this app, frequently asked questions and settings.

Now the last function of this app 1, not displayed to the public or end user, is the “Black Book.” The purpose of this “Black Book” is to store records of each individual “User's Account Activity.” This is done by scanning the ID after each and every transaction. Each User will have a different ID/barcode number. The ID/barcode number on each individual app 1 is linked back to a corresponding and/or matching “Black Book” number. As soon as an ID/barcode is scanned on the computing device, it automatically sends back that exact transaction information to the matching/corresponding “Black Book” code with the ID/barcode. This is in case fraud or foul play is suspected. The business, bank or user can go back and review anything that might have taken place. The “Black Book” stays with the server provider. It acts as an inspection log for businesses, banks and the user and is a database for the server and user. It is also a ledger for businesses and banks and it keeps track of added and subtracted cents. Three actions/Three links, from the User to the Business and to the “Black Book.” All three of these are linked together with identical numbers making sure everything is in sync. The user's barcode is scanned and the business system recognizes it and links it back to the “Black Book”. All data is stored in the “Black Book” using the worldwide Oracle Database.

In conjunction with this app 1 another embodiment would be a “Cents Back Card.” The main purpose of this card is for storing and saving change just like the application but in a magnetic card form. It is mainly for storing and saving cents but it can also be used to purchase merchandise once enough cents has been saved up. Just like the application 1, when people walk into a store, make a purchase with money and instead of getting cents back like quarters, dimes, nickels and pennies, they swipe the card and whatever cents they were supposed to get back will turn into cryptocents. A user will get your cents back but in digital form and with the same spending power. The card can either be a chip and signature card or a chip and pin card. It will be a chip based card with newest and latest chip technology. It will work with square readers, magnetic stripe reads, NFC (near field communication), MST (magnetic secure transmission), EMV Terminal (Europay, Mastercard, Visa) CAP (chip authentication program). It sends two pieces of data to the payment terminal/Black Book. First, in the preferred embodiment, it will have a 16 digit token that represents the card number. Second, it is a one time code or cryptogram that's generated after it is swiped and it becomes an encryption key. EMV, encryption, tokenization and 3-D secure all work together to protect the card holder's data. The standard card size is CR80 and can be manufactured with all these different types of plastic material PVC, ABS, PET and PETG plastic. It will work with any ATM or bank so a user can deposit cents into their personal bank account. To get change back from a purchase swipe a card once, enter the pin, hit cash back, than hit other. The cashier types in the amount ranging from 1 cent to 99 cents. After the cashier types in the amount, a user will then swipe it again. Change is added to the “Cents Back Card” then the user is good to go.

### Advantages

The current invention allows the consumer not to have to deal with having coins in their pockets or scattered all over there house or any other place people keep their change like a jar or zip lock bags or just thrown on their dresser at the end of the day. it will always be put straight into their bank account for them so they don't have to deal with the coins anymore it will be handled for them.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
a computing device having a system that resides in non-transitory memory;
having a display unit, input function,
storing cents in an electronic form after purchases to be redeemed later.

2. A system according to claim 1 having the users set up profiles.

3. A system according to claim 1 allowing the transferring of the stored cents.

4. A system according to claim 1 having a unique identification code attached to an account where the cents is transferred to.

5. A system according to claim 4 where the unique identification code is a barcode.

6. A system according to claim 4 where the unique identification code is scanned and the system will confirm that the transfer was successful.

7. A system according to claim 1 having a menu bar.

8. A system according to claim 7 where the menu bar will have one or more function tabs from the group of account activity, transfer to, deduct, individual cents, how to and black book.

9. A system according to claim 8 where the account activity reviews transaction.

10. A system according to claim 8 where transfer to function transfers cents to from a bank account or another.

11. A system according to claim 8 where deduct function deducts cents for tax.

12. A system according to claim 8 where the individual cents function shows how much each individual cents has been accumulated.

13. A system according to claim 8 where the how to function shows how all instructions and functions are used.

14. A system according to claim 8 where the black book function is to store records of each individual account activity.

15. A device comprising;
a card with memory which is used to store cents in an electronic form after purchases to be redeemed later.

16. A device according to claim 15 where the card is a chip and signature card.

17. A device according to claim 15 where the card is a chip and pin card.

18. A device according to claim 15 where the card will work with one or more of a group of square readers, magnetic stripe reads, near field communication, magnetic secure transmission, EMV Terminal (Europay, Mastercard, Visa) CAP (chip authentication program).

18. A device according to claim 15 having a 16 digit token that represents the card number.

19. A device according to claim 15 is a standard card size is CR80.

20. A system comprising;
a computing device having a system that resides in non-transitory memory;
having a display unit, input function,
storing cents in an electronic form after purchases to be redeemed later,
having the users set up profiles,
allowing the transferring of the stored cents,
having a unique identification code attached to an account where the cents is transferred to,
where the unique identification code is scanned and the system will confirm that the transfer was successful, and
having a menu bar where the menu bar will have one or more function tabs from the group of account activity, transfer to, deduct, individual cents, how to and black book.
